(19) United States
(12) Patent Application Publication
(10) Pub. No.: US 2007/0150866 A1
(43) Pub. Date: Jun. 28, 2007

(54) Displaying parameters associated with call statements

(75) Inventors: Cary Lee Bates, Rochester, MN (US); James Edward Carey, Rochester, MN (US)

Correspondence Address: IBM CORPORATION;ROCHESTER IP LAW DEPT. 917, 3605 HIGHWAY 52 NORTH, ROCHESTER, MN, 55901-7829, US

(73) Assignee: INTERNATIONAL BUSINESS MACHINES CORPORATION, ARMONK, NY (US)

(21) Appl. No.: 11/316,249

(22) Filed: Dec. 22, 2005

(51) Int. Cl. G06F 9/44

(52) U.S. Cl. 717/124

(57) ABSTRACT

A method, apparatus, system, and signal-bearing medium that, in an embodiment, in response to a call statement and a parameter statement in a source program, generate parameter executable instructions, temporary executable instructions, and a call executable instruction in an executable program. When executed, the parameter executable instructions load a parameter indicated in the parameter statement to a parameter area. When executed, the temporary executable instructions store the parameter in a temporary variable. When executed, the call executable instruction calls a function that accesses the parameter from the parameter area. In response to a display parameters action directed to the call statement, the parameter executable instructions and the temporary executable instructions are executed. The executable program is then halted after the temporary executable instructions and before the call executable instruction, and the parameter is retrieved from the temporary variable and displayed. In an embodiment, in response to a step over action directed to the call statement, the parameter executable instructions, the temporary executable instructions, and the call instruction are executed. In this way, the parameter values of call statements may be displayed.

### FIELD

An embodiment of the invention generally relates to debugging computer programs. In particular, an embodiment of the invention generally relates to displaying parameters associated with call statements in computer programs.

### BACKGROUND

The development of the EDVAC computer system of 1948 is often cited as the beginning of the computer era. Since that time, computer systems have evolved into extremely sophisticated devices, and computer systems may be found in many different settings. Computer systems typically include a combination of hardware, such as semiconductors and circuit boards, and software, also known as computer programs. As advances in semiconductor processing and computer architecture push the performance of the computer hardware higher, more sophisticated and complex computer software has evolved to take advantage of the higher performance of the hardware, resulting in computer systems today that are much more powerful than just a few years ago.

As the sophistication and complexity of computer software increase, the more difficult the software is to debug. Bugs are problems, faults, or errors in a computer program. Locating, analyzing, and correcting suspected faults in a computer program is a process known as “debugging.” Typically, a programmer uses another computer program commonly known as a “debugger” to debug the program under development.

Conventional debuggers typically support two primary operations to assist a computer programmer. A first operation supported by conventional debuggers is a “step” function, which permits a computer programmer to process instructions (also known as “statements”) in a computer program one-by-one and see the results upon completion of each instruction. While the step operation provides a programmer with a large amount of information about a program during its execution, stepping through hundreds or thousands of program instructions can be extremely tedious and time consuming and may require the programmer to step through many program instructions that are known to be error-free before a set of instructions to be analyzed is finally executed.

To address this difficulty, a second operation supported by conventional debuggers is a breakpoint operation, which permits a computer programmer to identify with a breakpoint a precise instruction for which it is desired to halt execution of a computer program during execution. As a result, when a computer program is executed by a debugger, the program executes in a normal fashion until the breakpoint is reached. The debugger then stops execution of the program and displays the results of the program and/or the state of the computer system to the programmer for analysis, typically via a debugger user interface.

Typically, step operations and breakpoints are used together to simplify the debugging process. Specifically, a common debugging operation is to set a breakpoint at the beginning of a desired set of instructions to be analyzed and then begin executing the program. Once the breakpoint is reached, the debugger halts the program, and the programmer then steps through the desired set of instructions line-by-line using the step operation. Consequently, a programmer is able to more quickly isolate and analyze a particular set of instructions without needing to step through irrelevant portions of a computer program.

Portions of a computer program that are difficult to debug using a conventional debugger are function or method calls with parameters that must be calculated. For example, if the developer sets a breakpoint at the function call “foo(x, a+b),” not only are the parameters not identified in the local variables when the break point is encountered, but the parameter values might not be even be computed yet. For example, a breakpoint set at the call statement “foo(x, a+b)” is set prior to the first executable instruction that implements the call statement, so that when the breakpoint is encountered, the result of “a+b” is not yet calculated. This causes the developer difficulties in determining what values the called function will be passed because the developer must, e.g., step into the called function, examine the incoming registers associated with the called function and then switch back to the calling function to determine the context of the variables.

Hence, without a better way to determine parameters that are passed to functions, developers will continue to experience difficulty when debugging programs.

### SUMMARY

A method, apparatus, system, and signal-bearing medium are provided that, in an embodiment, in response to a call statement and a parameter statement in a source program, generate parameter executable instructions, temporary executable instructions, and a call executable instruction in an executable program. When executed, the parameter executable instructions load a parameter indicated in the parameter statement to a parameter area. When executed, the temporary executable instructions store the parameter in a temporary variable. When executed, the call executable instruction calls a function that accesses the parameter from the parameter area. In response to a display parameters action directed to the call statement, the parameter executable instructions and the temporary executable instructions are executed. The executable program is then halted after the temporary executable instructions and before the call executable instruction, and the parameter is retrieved from the temporary variable and displayed. In an embodiment, in response to a step over action directed to the call statement, the parameter executable instructions, the temporary executable instructions, and the call instruction are executed. In this way, the parameter values of call statements may be displayed.

### BRIEF DESCRIPTION OF THE DRAWING

Various embodiments of the present invention are hereinafter described in conjunction with the appended drawings:

FIG. 1 depicts a block diagram of an example system for implementing an embodiment of the invention.

FIG. 2 depicts a block diagram of an example source program and executable program, according to an embodiment of the invention.

FIG. 3 depicts a block diagram of a statement view, according to an embodiment of the invention.

FIG. 4 depicts a block diagram of a mapping table, according to an embodiment of the invention.

FIG. 5 depicts a block diagram of a symbol table, according to an embodiment of the invention.

FIG. 6 depicts a flowchart of example processing for a compiler, according to an embodiment of the invention.

FIG. 7 depicts a flowchart of example processing for a debugger, according to an embodiment of the invention.

It is to be noted, however, that the appended drawings illustrate only example embodiments of the invention, and are therefore not considered limiting of its scope, for the invention may admit to other equally effective embodiments.

### DETAILED DESCRIPTION

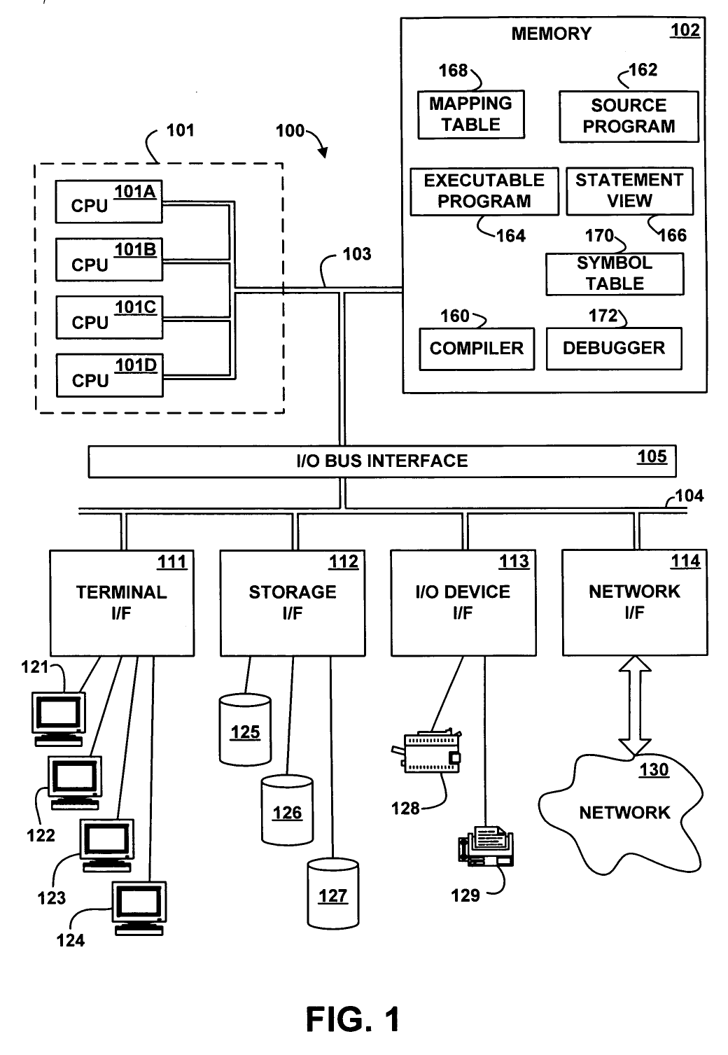

Referring to the Drawings, wherein like numbers denote like parts throughout the several views, FIG. 1 depicts a high-level block diagram representation of a computer system 100 connected to a network 130, according to an embodiment of the present invention. The major components of the computer system 100 include one or more processors 101, a main memory 102, a terminal interface 111, a storage interface 112, an I/O (Input/Output) device interface 113, and communications/network interfaces 114, all of which are coupled for inter-component communication via a memory bus 103, an 1/0 bus 104, and an I/O bus interface unit 105.

The computer system 100 contains one or more general-purpose programmable central processing units (CPUs) 101A, 101B, 101C, and 101D, herein generically referred to as a processor 101. In an embodiment, the computer system 100 contains multiple processors typical of a relatively large system; however, in another embodiment the computer system 100 may alternatively be a single CPU system. Each processor 101 executes instructions stored in the main memory 102 and may include one or more levels of on-board cache.

The main memory 102 is a random-access semiconductor memory for storing data and programs. The main memory 102 is conceptually a single monolithic entity, but in other embodiments the main memory 102 is a more complex arrangement, such as a hierarchy of caches and other memory devices. For example, memory may exist in multiple levels of caches, and these caches may be further divided by function, so that one cache holds instructions while another holds non-instruction data, which is used by the processor or processors. Memory may further be distributed and associated with different CPUs or sets of CPUs, as is known in any of various so-called non-uniform memory access (NUMA) computer architectures.

The memory 102 includes a compiler 160, a source program 162, an executable program 164, a statement view 166, a mapping table 168, a symbol table 170, and a debugger 172. Although the compiler 160, the source program 162, the executable program 164, the statement view 166, the mapping table 168, the symbol table 170, and the debugger 172 are illustrated as being contained within the memory 102 in the computer system 100, in other embodiments some or all of them may be on different computer systems and may be accessed remotely, e.g., via the network 130. The computer system 100 may use virtual addressing mechanisms that allow the programs of the computer system 100 to behave as if they only have access to a large, single storage entity instead of access to multiple, smaller storage entities. Thus, while the compiler 160, the source program 162, the executable program 164, the statement view 166, the mapping table 168, the symbol table 170, and the debugger 172 are illustrated as being contained within the main memory 102, these elements are not necessarily all completely contained in the same storage device at the same time.

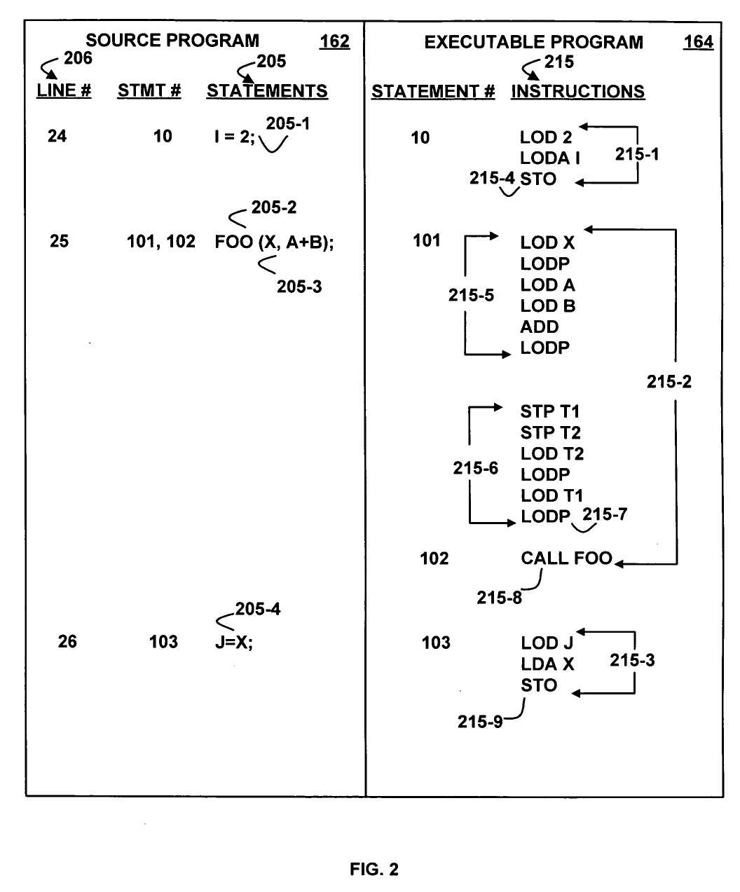

The compiler 160 compiles the source program 162 into the executable program 164, which is capable of executing on the processor 101. The source program 162 is program being debugged. The source program 162 includes compliable statements. In various embodiments, the source program 162 may be an application program, an operating system program, a user application, a third party application, or any other type of program. The source program 162 and the executable program 164 are further described below with reference to FIG. 2.

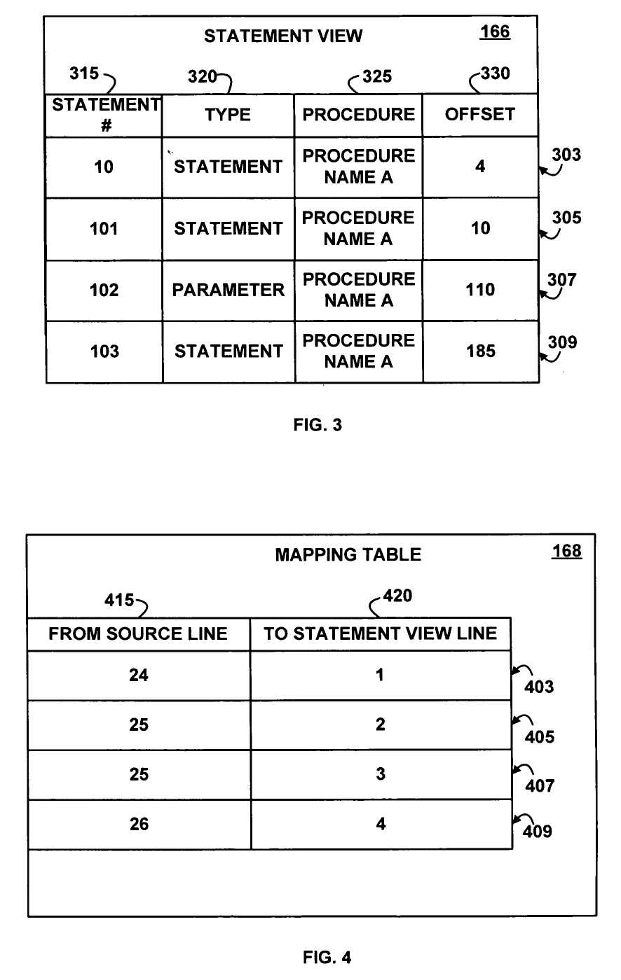

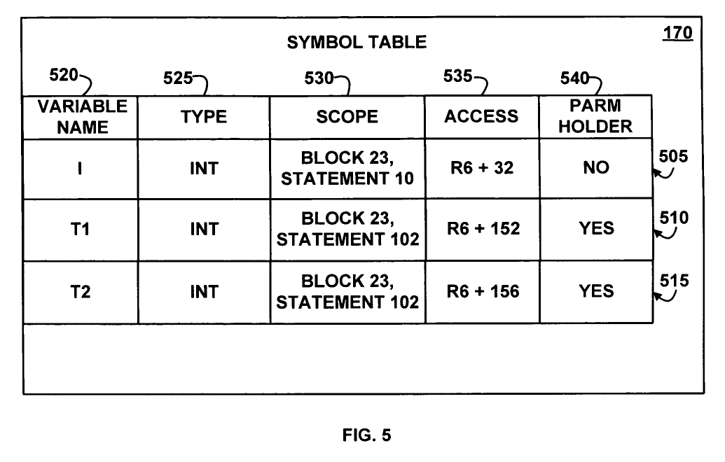

The statement view 166 includes information regarding the statements in the source program 162. The statement view 166 is further described below with reference to FIG. 3. The mapping table 168 represents the mapping of source lines in the source program 162 to records in the statement view 166. The mapping table 168 is further described below with reference to FIG. 4. The symbol table 170 represents variables in the source program 162 and the executable program 164. The symbol table 170 is further described below with reference to FIG. 5.

The debugger 172 provides breakpoints to be established by interacting with a user and actions, such as a step over action and a display parameters action, but in other embodiments any type of actions may be provided. In some embodiments, the user may define the breakpoints and request actions by issuing a debugger command that refers to high-level language (HLL) references in the source program 162, such as line or statement numbers or software object references such as a program or module name, from which the physical storage address may be cross referenced. In various embodiments, the debugger command may be issued on a command line or through a graphical user interface. The debugger 172 parses this debugger command using a table that was produced by the compiler 160 to map the line number in the debugger command to the actual physical storage address in the memory 102. The debugger 172 further interprets instructions and sets breakpoints in the executable program 164.

After the breakpoints are set, the user provides an input to the debug user interface that resumes execution of the executable program 164. Execution of the instructions 164 eventually results in an encounter of a breakpoint. In an embodiment, this is accomplished by an instruction that fails, causing a system exception, which gives control to the debugger 172. Then the debugger 172 may receive further commands or actions via a user interface, such as one displayed on the terminals 121, 122, and/or 123.

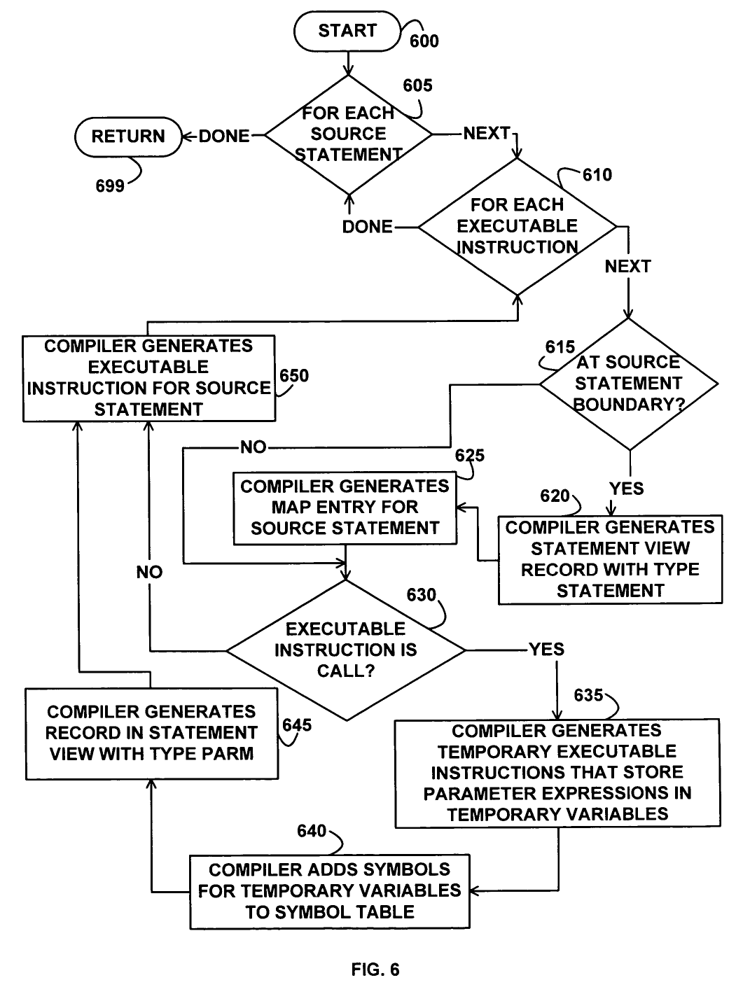

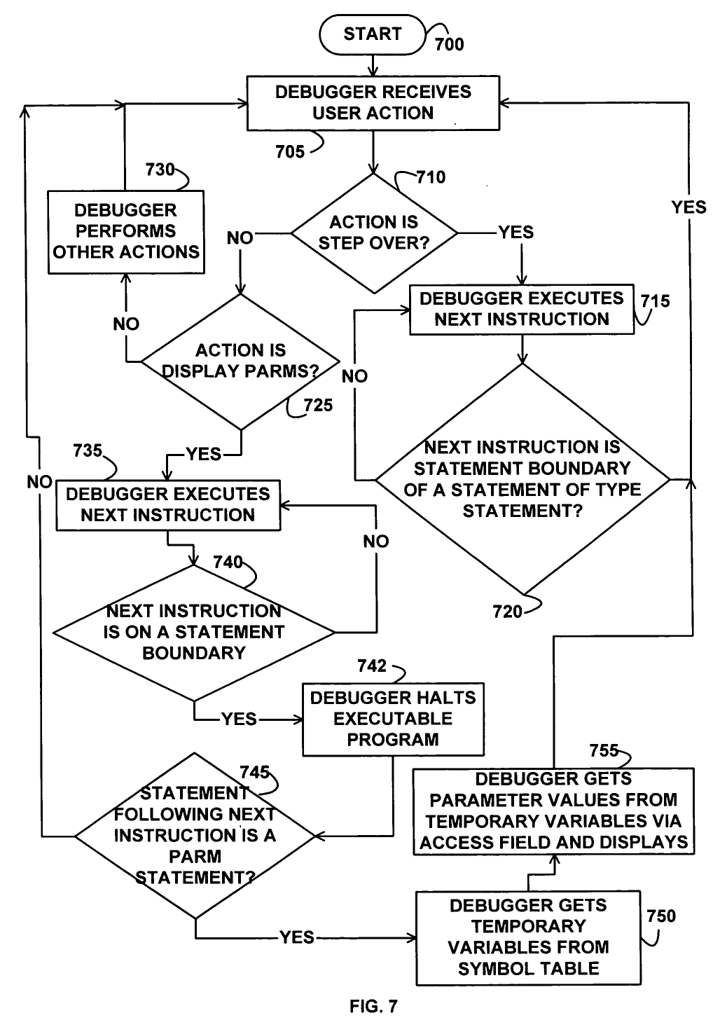

In an embodiment, the compiler 160 and the debugger 172 include instructions capable of executing on the processor 101 or statements capable of being interpreted by instructions executing on the processor 101 to perform the functions as further described below with reference to FIGS. 6 and 7. In another embodiment, the compiler 160 and the debugger 172 may be implemented in microcode. In another embodiment, the compiler 160 and the debugger 172 may be implemented in hardware via logic gates and/or other appropriate hardware techniques.

The memory bus 103 provides a data communication path for transferring data among the processor 101, the main memory 102, and the I/O bus interface unit 105. The I/O bus interface unit 105 is further coupled to the system I/O bus 104 for transferring data to and from the various I/O units. The I/O bus interface unit 105 communicates with multiple I/O interface units 111, 112, 113, and 114, which are also known as I/O processors (IOPs) or I/O adapters (IOAs), through the system I/O bus 104. The system I/O bus 104 may be, e.g., an industry standard PCI bus, or any other appropriate bus technology.

The I/O interface units support communication with a variety of storage and I/O devices. For example, the terminal interface unit 111 supports the attachment of one or more user terminals 121, 122, 123, and 124. The storage interface unit 112 supports the attachment of one or more direct access storage devices (DASD) 125, 126, and 127 (which are typically rotating magnetic disk drive storage devices, although they could alternatively be other devices, including arrays of disk drives configured to appear as a single large storage device to a host). The contents of the main memory 102 may be stored to and retrieved from the direct access storage devices 125, 126, and 127.

The I/O device interface 113 provides an interface to any of various other input/output devices or devices of other types. Two such devices, the printer 128 and the fax machine 129, are shown in the exemplary embodiment of FIG. 1, but in other embodiment many other such devices may exist, which may be of differing types. The network interface 114 provides one or more communications paths from the computer system 100 to other digital devices and computer systems; such paths may include, e.g., one or more networks 130.

Although the memory bus 103 is shown in FIG. 1 as a relatively simple, single bus structure providing a direct communication path among the processors 101, the main memory 102, and the I/O bus interface 105, in fact the memory bus 103 may comprise multiple different buses or communication paths, which may be arranged in any of various forms, such as point-to-point links in hierarchical, star or web configurations, multiple hierarchical buses, parallel and redundant paths, etc. Furthermore, while the I/O bus interface 105 and the I/O bus 104 are shown as single respective units, the computer system 100 may in fact contain multiple I/O bus interface units 105 and/or multiple I/O buses 104. While multiple I/O interface units are shown, which separate the system I/O bus 104 from various communications paths running to the various I/O devices, in other embodiments some or all of the I/O devices are connected directly to one or more system I/O buses.

The computer system 100 depicted in FIG. 1 has multiple attached terminals 121, 122, 123, and 124, such as might be typical of a multi-user “mainframe” computer system. Typically, in such a case the actual number of attached devices is greater than those shown in FIG. 1, although the present invention is not limited to systems of any particular size. The computer system 100 may alternatively be a single-user system, typically containing only a single user display and keyboard input, or might be a server or similar device which has little or no direct user interface, but receives requests from other computer systems (clients). In other embodiments, the computer system 100 may be implemented as a personal computer, portable computer, laptop or notebook computer, PDA (Personal Digital Assistant), tablet computer, pocket computer, telephone, pager, automobile, teleconferencing system, appliance, or any other appropriate type of electronic device.

The network 130 may be any suitable network or combination of networks and may support any appropriate protocol suitable for communication of data and/or code to/from the computer system 100. In various embodiments, the network 130 may represent a storage device or a combination of storage devices, either connected directly or indirectly to the computer system 100. In an embodiment, the network 130 may support Infiniband. In another embodiment, the network 130 may support wireless communications. In another embodiment, the network 130 may support hard-wired communications, such as a telephone line or cable. In another embodiment, the network 130 may support the Ethernet IEEE (Institute of Electrical and Electronics Engineers) 802.3× specification. In another embodiment, the network 130 may be the Internet and may support IP (Internet Protocol). In another embodiment, the network 130 may be a local area network (LAN) or a wide area network (WAN). In another embodiment, the network 130 may be a hotspot service provider network. In another embodiment, the network 130 may be an intranet. In another embodiment, the network 130 may be a GPRS (General Packet Radio Service) network. In another embodiment, the network 130 may be a FRS (Family Radio Service) network. In another embodiment, the network 130 may be any appropriate cellular data network or cell-based radio network technology. In another embodiment, the network 130 may be an IEEE 802.11B wireless network. In still another embodiment, the network 130 may be any suitable network or combination of networks. Although one network 130 is shown, in other embodiments any number (including zero) of networks (of the same or different types) may be present.

It should be understood that FIG. 1 is intended to depict the representative major components of the computer system 100 at a high level, that individual components may have greater complexity than represented in FIG. 1, that components other than or in addition to those shown in FIG. 1 may be present, and that the number, type, and configuration of such components may vary. Several particular examples of such additional complexity or additional variations are disclosed herein; it being understood that these are by way of example only and are not necessarily the only such variations.

The various software components illustrated in FIG. 1 and implementing various embodiments of the invention may be implemented in a number of manners, including using various computer software applications, routines, components, programs, objects, modules, data structures, etc., referred to hereinafter as “computer programs,” or simply “programs.” The computer programs typically comprise one or more instructions that are resident at various times in various memory and storage devices in the computer system 100, and that, when read and executed by one or more processors 101 in the computer system 100, cause the computer system 100 to perform the steps necessary to execute steps or elements comprising the various aspects of an embodiment of the invention.

Moreover, while embodiments of the invention have and hereinafter will be described in the context of fully functioning computer systems, the various embodiments of the invention are capable of being distributed as a program product in a variety of forms, and the invention applies equally regardless of the particular type of signal-bearing medium used to actually carry out the distribution. The programs defining the functions of this embodiment may be delivered to the computer system 100 via a variety of signal-bearing media, which include, but are not limited to:

(1) information permanently stored on a non-rewriteable storage medium, e.g., a read-only memory device attached to or within a computer system, such as a CD-ROM, DVD-R, or DVD+R;

(2) alterable information stored on a rewriteable storage medium, e.g., a hard disk drive (e.g., the DASD 125, 126, or 127), CD-RW, DVD-RW, DVD+RW, DVD-RAM, or diskette; or

(3) information conveyed by a communications medium, such as through a computer or a telephone network, e.g., the network 130.

Such tangible signal-bearing media, when carrying computer-readable instructions that direct the functions of the present invention, represent embodiments of the present invention.

Embodiments of the present invention may also be delivered as part of a service engagement with a client corporation, nonprofit organization, government entity, internal organizational structure, or the like. Aspects of these embodiments may include configuring a computer system to perform, and deploying software systems and web services that implement, some or all of the methods described herein. Aspects of these embodiments may also include analyzing the client company, creating recommendations responsive to the analysis, generating software to implement portions of the recommendations, integrating the software into existing processes and infrastructure, metering use of the methods and systems described herein, allocating expenses to users, and billing users for their use of these methods and systems. In addition, various programs described hereinafter may be identified based upon the application for which they are implemented in a specific embodiment of the invention. But, any particular program nomenclature that follows is used merely for convenience, and thus embodiments of the invention should not be limited to use solely in any specific application identified and/or implied by such nomenclature.

The exemplary environments illustrated in FIG. 1 are not intended to limit the present invention. Indeed, other alternative hardware and/or software environments may be used without departing from the scope of the invention.

FIG. 2 depicts a block diagram of an example source program 162 and an example executable program 164, according to an embodiment of the invention. The source program 162 includes source statements 205, which generically refers to the example source statements 205-1, 205-2, 205-3, and 205-4. The source program 162 may be organized into the statements 205 and lines 206, where a line 206 in the source program 162 may contain one or more statements 205. For example, the line “25” includes a call statement of a function, which is the source call statement 205-2 with statement number “101 ” and the parameters of the function call, which is the source parameter statement 205-3 with statement number “102.”

The executable program 164 includes executable instructions 215, which generically refers to the example instructions 215-1, 215-2, 215-3, 215-4, 215-5, 215-6, 215-7, 215-8, and 215-9. The executable instructions 215-1 includes the executable instruction 215-4. The executable instructions 215-2 include the executable instructions 215-5, 215-6, and 215-8. The executable instructions 215-6 includes the executable instruction 215-7. The executable instructions 215-3 includes the executable instruction 215-9.

The compiler 160 generates the executable instructions 215-1 from the statement 205-1, generates the executable instructions 215-2 from the source call statement 205-2 and the source parameter statement 205-3, and generates the executable instructions 215-3 from the source statement 205-4.

The compiler 160 generates the parameter executable instructions 215-5, which are a portion of the executable instructions 215-2, based on the statement “102,” which when executed load the values of the parameters indicated in the parameter statement 205-3 into a parameter area, e.g., of a stack. For example “LOD X” loads the value of the variable “X” to the top of a stack, and “LODP” loads the top of the stack (which now contains the value of the variable “X”) to the top of a parameter area stack. “LOD A” loads the value of the variable “A” to the top of the stack, “LOD B” loads the value of the variable “B” to the top of the stack, and “ADD” adds the top two entries of the stack and places the result at the top of the stack, which calculates the value of the parameter “A+B.” “LODP” then loads the value of the top of the stack, which is now the calculated result “A+B” to the top of the parameter area stack. Thus, following execution of the parameter executable instructions 215-5, the values of the parameters “X” and “A+B” are calculated or evaluated by the parameter instructions 215-5 and are at the top of the parameter area stack.

The compiler 160 generates the temporary executable instructions 215-6, which are a portion of the executable instructions 215-2, based on the source call statement 205-2 and source parameter statement 205-3 in order to calculate and store the parameter expression of the statement 205-3 in temporary variables, as further described below with reference to FIG. 6. For example, “STP T1” stores the top of the parameter area stack into the temporary variable “T1,” and “STP T2” stores the top of the parameter area stack into the temporary variable “T2.” Since “STP T1” and “STP T2” removed the parameters from the parameter area stack, they must be restored, so “LOD T2” loads the value of the temporary variable T1 to the top of the stack, and LODP loads the top of the stack to the top of the parameter area stack. Similarly, “LOD T1” loads the value of the temporary variable T2 to the top of the stack, and “LODP” loads the top of the stack to the top of the parameter area stack.

The debugger 172 uses the temporary variables generated by the temporary instructions 215-6, as further described below with reference to FIG. 7. The executable instructions 215-4, 215-7, 215-8, and 215-9 are at statement boundaries, meaning that they are the last executable instructions generated for their respective statements 205-1, 205-2, 205-3, and 205-4.

The call executable instruction 215-8 is a call instruction, meaning that when executed by the processor 101, the control flow of the executable program 164 jumps to the instruction location identified by “foo,” and the parameter values (the value in variable “X” and the calculated value of the variable “A” plus the value of the variable “B”) that were loaded into the parameter area by the executable instructions 215-2 are read, referenced, accessed, or used by the executable instructions at the “foo” location. “Foo” indications a function, such as a program, method, procedure, or any other unit of statements or instructions.

FIG. 3 depicts a block diagram of a statement view 166, according to an embodiment of the invention. The statement view 166 includes records 303, 305, 307, and 309, each of which includes a statement number field 315, a type field 320, a procedure field 325, and a offset field 330. The statement number field 315 indicates statements numbers in the source program 162, such as the statement number “101” in the record 305, indicating the source call statement 205-2 and the statement number “102” in the record 307, indicating the source parameter statement 205-3. The type field 320 indicates the type of the statement associated with the respective statement number 315, such as a regular (non-parameter) statement or a statement that includes parameters of a function call. An example of a statement that includes parameters of a function call is the source parameter statement 205-3 with a statement number of “102,” as indicated in the record 307. The procedure field 325 indicates the procedure in which the statement associated with the respective statement number 315 resides. The offset field 330 indicates the offset (in bytes or any other appropriate units) from the beginning of the source program 162 to the statement associated with the statement number 315.

FIG. 4 depicts a block diagram of a mapping table 168, according to an embodiment of the invention. The mapping table 168 includes records 403, 405, 407, and 409, each of which includes a from-source line field 415 and a to-statement view line 420. The from-source line field 415 indicates a line in the source program 162. The to-statement view line 420 indicates the record (e.g., the records 303, 305, 307 or 309) in the statement view 166 that is associated with the respective from-source line 415. Thus, the mapping table 168 maps lines in the source program 162 to records in the statement view 166. In another embodiment, the from-source line field 415 may be included in the statement view 166.

FIG. 5 depicts a block diagram of the symbol table 170, according to an embodiment of the invention. The symbol table 170 includes rows 505, 510, and 515, each of which includes a variable name field 520, a type field 525, a scope field 530, an access field 535, and a parameter holder field 540. The variable name field 520 indicates the name of the variables used by the source program 162 and the executable program 164. The type field 525 indicates the type of the variable 520. For example the records 505, 510, and 515 indicate that the variables 520 of I, T1, and T2 are all integers, but in other embodiments any appropriate type 525 may be used. The scope field 530 indicates the scope of the variable 520 within the source program 162. For example, the record 505 indicates that the variable 520 of I is accessed at statement “10” within “block 23” of the source program 162, the record 510 indicates that the variable 520 of T1 is accessed at statement “102” within “block 23” of the source program 162, and the record 515 indicates that the variable 520 of T2 is accessed at statement “102” within “block 23” of the source program 162. In an embodiment, the source program 162 may be divided into blocks, but in other embodiments, the statements in the source program 162 may be divided into any appropriate segments.

The access field 535 indicates the storage location of the variable 520. For example, in record 505 the access field 535 indicates that the variable 520 of “I” is stored at a storage location indicated by the contents of register R6 plus 32, in the record 510 the access field 535 indicates that the variable 520 of TI is stored at a storage location indicated by the contents of register R6 plus 152, and in the record 515 the access field 535 indicates that the variable 520 of T2 is stored at a storage location indicated by the contents of register R6 plus 156.

The parameter holder field 540 indicates whether the variable 520 holds (or contains) a value of a parameter. For example, as indicated in the record 505, the variable 520 of I does not hold a parameter value, but as indicated in the records 510 and 515, the variables 520 of T1 and T2 do hold parameter values. Thus, the parameter holder field 540 indicates whether the variable 520 is a temporary variable.

FIG. 6 depicts a flowchart of example processing for the compiler 160, according to an embodiment of the invention. Control begins at block 600. Control then continues to block 605 where the compiler 160 begins a loop that is executed once for each source statement in the source program 162. So long as a current statement remains that is unprocessed by the loop, control continues to block 610 where the compiler 160 enters a loop that is executed once for each executable instruction that is generated by the compiler 160 for the current source statement. So long as a current executable instruction remains to be generated, the compiler 160 determines the current executable instruction that needs to be generated for the current source statement and control continues from block 610 to block 615 where the compiler 160 determines whether the current executable instruction that needs to be generated is at a statement boundary, meaning that the current executable instruction is the last executable instruction generated for the current source statement. Examples of executable instructions that are at statement boundaries are the executable instructions 215-4, 215-7, 215-8, and 215-9 in FIG. 2.

If the determination at block 615 is true, then the current executable instruction is at a statement boundary, so control continues to block 620 where the compiler 160 generates a statement view record for the current source statement, storing the statement number 315 of the current statement, the type 320 indicating a regular (non-parameter) statement, the procedure (if applicable), and the offset 330 associated with the current statement. Control then continues to block 625 where the compiler 160 generates a map record in the mapping table 168 for the current source statement, storing the from-source line 415 and the to-statement view line 420 for the current source statement.

Control then continues to block 630 where the compiler 160 determines whether the current executable instruction is a call instruction, e.g., the call instruction 215-8. A call instruction calls, invokes, jumps to, or changes the control flow to a function, procedure, method or other group of executable instructions. If the determination at block 630 is true, then the current executable instruction is a call instruction, so control continues to block 635 where the compiler 160 generates the temporary executable instructions 215-6 that store the parameters of the call instruction (the parameters indicated in the parameter statement 205-3) in temporary variables. The temporary executable instructions 215-6 are to be executed prior to the call instruction 215-8.

Control then continues to block 640 where the compiler 160 adds a record or records (e.g., the records 510 and 515) for the generated temporary variables to the symbol table 170, storing the variable name 520, the type 525, the scope 530, the access 535, and the parameter holder 540, indicating that the variable name 520 holds parameters.

Control then continues to block 645 where the compiler 160 generates a record in the statement view 166 for the current statement, e.g., the compiler 160 generates the record 307 with a type 320 indicating that the current statement for which the executable instructions were generated at block 635 is a parameter statement because the call instruction 215-8 passes parameters and is generated in response to the statement 205-3 “102.” Control then continues to block 650 where the compiler 160 generates the current executable instruction (in this case the call instruction 215-8) for the current source statement (in this case the source statement 205-3 of “102”). The compiler 160 stores the call executable instruction 215-8 into the executable program 164 subsequent to the temporary executable instructions 215-6 that store the calculated parameters into the temporary variables, so that the temporary variables will be stored prior to the call executable instruction 215-8. Control then returns to block 610 where the compiler 160 determines the next current executable instruction, as previously described above.

If the determination at block 630 is false, then the current executable instruction is not a call instruction, so control continues to block 650 where the compiler 160 generates the current executable instruction for the current source statement. For example, the compiler 160 generates the executable instructions 215-1 from the source statement 205-1, generates the parameter executable instructions 215-5 from the source statement 205-2, and generates the executable instructions 215-3 from the source statement 205-4. Control then returns to block 610 where the compiler 160 determines the next current executable instruction, as previously described above.

If the determination at block 615 is false, then the current executable instruction is not at a source statement boundary, so control continues to block 630, as previously described above.

When all executable instructions have been generated for the current source statement by the loop that starts at block 610, then the loop is done, so control returns from block 610 to block 605, as previously described above.

When all source statements have been processed by the loop that starts at block 605, then the loop is done, so control continues to block 699 where the logic of FIG. 6 returns.

FIG. 7 depicts a flowchart of example processing for the debugger 172, according to an embodiment of the invention. Control begins at block 700. Control then continues to block 705 where the debugger 172 receives a user action via a user interface. Control then continues to bock 710 where the debugger 172 determines whether the received action is a step over action. A step over action is a request from the user to execute the instructions that are associated with a statement to a statement boundary. Since several instructions may be needed to implemented a single statement, in response to the step over action, the debugger 172 may need to execute multiple instructions to the statement boundary.

If the determination at block 710 is true, then the received action is a step over action, so control continues to block 715 where the debugger 172 executes the next instruction, meaning that the debugger 172 sends the next executable instruction to the processor 101, which executes it.

Control then continues to block 720 where the debugger 172 determines whether the next instruction (which was just executed at block 715) is at a statement boundary of a statement that has a type 320 indicating that the statement is not a parameter (has a type 320 of statement). In an embodiment, the debugger 172 makes the determination of block 720 by comparing the offset of the next instruction from the start of the executable program 164 to the offset 330 in the statement view 166 and searching for a record where the offsets are equal. If such a record is found, a statement boundary exists following the next instruction. The debugger 172 then checks the type 320 in the found record and determines whether the type 320 indicates that the statement is not a parameter.

If the determination at block 720 is true, then the statement associated with the next instruction whose statement boundary has been reached is not a parameter statement (e.g., is not the parameter statement 205-3), so control returns to block 705, where the debugger 172 receives the next user action as previously described above.

If the determination at block 720 is false, then the next instruction is not at a statement boundary of a statement with a type of statement (non-parameter), so control returns to block 715 where the debugger 172 moves execution to the next instruction, as previously described above.

Thus, in response to a step over action directed to the call statement 205-2, the debugger 172, as illustrated by blocks 715 and 720, executes the parameter executable instructions 215-5, executes the temporary executable instructions 215-6, and executes the call instruction 215-8. Thus, in response to a step over action directed to the call statement 205-2, the debugger 172 executes the parameter executable instructions 215-5, the temporary executable instructions 215-6, and the call executable instruction 215-8, which are associated with both the call statement 205-2 and the parameter statement 205-3.

If the determination at block 710 is false, then the received action is not a step over action, so control continues to block 725 where the debugger 172 determines whether the received action is a display parameters action. The display parameter action is directed to the call statement 205-2 if the display parameter action is initiated while the executable program 164 is halted at a statement boundary prior to the call statement 205-2.

If the determination at block 725 is true, then the received action is a display parameters action, so control continues to block 735 where the debugger 172 executes the next instruction in the executable program 164. The next instruction is one of the instructions of the parameter executable instructions 215-5 and temporary executable instructions 215-6.

Control then continues to block 740 where the debugger 172 determines whether the next instruction is on a statement boundary. In an embodiment, a statement boundary occurs between executable instructions that were generated by the compiler 160 from different source statements in the source program 162. In an embodiment, the debugger 172 makes the determination of block 740 by comparing the offset of instruction following the next instruction to the offset 330. If the offsets of the following instruction matches (is equal to) an offset 330, then the following instruction is the first instruction that implements a statement, so the next instruction is at a statement boundary.

If the determination at block 740 is false, then the next instruction is not on a statement boundary, so control returns to block 735 where the debugger 172 moves to the next instruction in the executable program 164 and executes the next instruction, as previously described above.

If the determination at block 740 is true, then the next instruction is on a statement boundary, so control continues to block 742 where the debugger 172 halts the execution of the executable program 164. Thus, in the operation of blocks 735, 740, and 742, the debugger 172 executes the executable program 164 in response to the display parameters action until the next executable instruction is on a statement boundary, which causes the debugger 172 to halt the execution of the executable program 164.

Control then continues to block 745 where the debugger 172 determines whether the statement following the next instruction is a statement that passes parameters. For example, if the next instruction is the call executable instruction 215-7, then the statement following the next instruction 215-7 is the statement “102” associated with the instruction 215-8, and the type 320 in the record 307 indicates that the statement 102 passes parameters, so the executable program 164 was halted (at block 742) between the executable instructions 215-7 and 215-8, which is at a statement boundary between the source statements 205-2 and 205-3 (between the statements “101” and “102”). Thus, the debugger 172 has halted the execution of the executable program 164 after the temporary executable instructions 215-6 and before the call executable instruction 215-8 (between the source call statement 205-2 and the source parameter statement 205-3), which is the boundary between the call statement 205-2 and the parameter statement 205-3 in the source program.

If the determination at block 745 is true, then the statement following the next instruction does pass parameters, so control continues to block 750 where the debugger 172 finds temporary variables from the symbol table 170 that have a parameter holder field 540 indicating that they contain parameters. Control then continues to block 755 where the debugger 172 retrieves values from the found temporary variables by accessing them via the access field 535 and displays the values for the temporary variables, which are the values of the evaluated parameters from the parameter statement 205-3 that the call instruction 215-8 will pass and which the temporary instructions 215-6 stored in the temporary variables. The values are displayed via a user interface, e.g., via the terminals 121, 122, 123, or 124. Control then returns to block 705, as previously described above.

If the determination at bock 745 is false, then the next instruction is not a parameter statement, so control returns to block 705, as previously described above.

If the determination at block 725 is false, then control continues to block 730 where the debugger 172 performs other actions. Control then returns to block 705 where the debugger 172 receives the next user action, as previously described above.

In the previous detailed description of exemplary embodiments of the invention, reference was made to the accompanying drawings (where like numbers represent like elements), which form a part hereof, and in which is shown by way of illustration specific exemplary embodiments in which the invention may be practiced. These embodiments were described in sufficient detail to enable those skilled in the art to practice the invention, but other embodiments may be utilized and logical, mechanical, electrical, and other changes may be made without departing from the scope of the present invention. Different instances of the word “embodiment” as used within this specification do not necessarily refer to the same embodiment, but they may. Any data and data structures illustrated or described herein are examples only, and in other embodiments, different amounts of data, types of data, fields, numbers and types of fields, field names, numbers and types of records, entries, or organizations of data may be used. In addition, any data may be combined with logic, so that a separate data structure is not necessary. The previous detailed description is, therefore, not to be taken in a limiting sense, and the scope of the present invention is defined only by the appended claims.

In the previous description, numerous specific details were set forth to provide a thorough understanding of the invention. But, the invention may be practiced without these specific details. In other instances, well-known circuits, structures, and techniques have not been shown in detail in order not to obscure the invention.

What is claimed is:

1. A method comprising:
in response to a call statement and a parameter statement in a source program, generating temporary executable instructions in an executable program that, when executed, store a parameter indicated in the parameter statement to a temporary variable; and
in response to a display parameters action directed to the call statement, executing the temporary executable instructions, halting the executable program, retrieving the parameter from the temporary variable, and displaying the parameter.

2. The method of claim 1, further comprising:
generating parameter executable instructions in the executable program that, when executed, load the parameter indicated in the parameter statement to a parameter area; and
generating a call executable instruction in the executable program that, when executed, calls a function that accesses the parameter from the parameter area.

3. The method of claim 2, further comprising:
in response to the display parameters action directed to the call statement,
executing the executable program, and
performing the halting of the executable program after the temporary executable instructions and before the call executable instruction.

4. The method of claim 3, wherein the halting further comprises:
executing the executable program until a boundary between the call statement and the parameter statement in the source program is reached.

5. The method of claim 2, wherein the display parameter action is directed to the call statement if the display parameter action is initiated while the executable program is halted at a statement boundary prior to the call statement.

6. The method of claim 2, further comprising:
in response to a step over action directed to the call statement, executing the parameter executable instructions, executing the temporary executable instructions, and executing the call instruction.

7. The method of claim 2, wherein the parameter further comprises a parameter expression, and wherein the temporary executable instructions further calculate the parameter expression.

8. A signal-bearing medium encoded with instructions, wherein the instructions when executed comprise:
in response to a call statement and a parameter statement in a source program,
generating parameter executable instructions in an executable program that, when executed, load a parameter indicated in the parameter statement to a parameter area,
generating temporary executable instructions in the executable program that, when executed, store the parameter in a temporary variable, and
generating a call executable instruction in the executable program that, when executed, calls a function that accesses the parameter from the parameter area; and
in response to a display parameters action directed to the call statement,
executing the parameter executable instructions,
executing the temporary executable instructions,
retrieving the parameter from the temporary variable, and
displaying the parameter.

9. The signal-bearing medium of claim 8, further comprising:
in response to the display parameters action directed to the call statement,
executing the executable program, and
halting the executing of the executable program after the temporary executable instructions and before the call executable instruction.

10. The signal-bearing medium of claim 9, wherein the halting further comprises:
executing the executable program until a boundary between the call statement and the parameter statement in the source program is reached.

11. The signal-bearing medium of claim 8, wherein the display parameter action is directed to the call statement if the display parameter action is initiated while the executable program is halted at a statement boundary prior to the call statement.

12. The signal-bearing medium of claim 8, further comprising:
in response to a step over action directed to the call statement,
executing the parameter executable instructions,
executing the temporary executable instructions, and
executing the call instruction.

13. The signal-bearing medium of claim 8, wherein the parameter further comprises a parameter expression, and wherein the temporary executable instructions further calculate the parameter expression.

14. The signal-bearing medium of claim 8, wherein the parameter area comprises a parameter stack.

15. A method for configuring a computer, comprising:
configuring the computer to, in response to a call statement and a parameter statement in a source program,
generate parameter executable instructions in an executable program that, when executed, load a parameter indicated in the parameter statement to a parameter area,
generate temporary executable instructions in the executable program that, when executed, store the parameter in a temporary variable, and
generate a call executable instruction in the executable program that, when executed, calls a function that accesses the parameter from the parameter area; and
configuring the computer to, in response to a display parameters action directed to the call statement,
execute the parameter executable instructions,
execute the temporary executable instructions,
retrieve the parameter from the temporary variable, and
display the parameter.

16. The method of claim 15, further comprising:
configuring the computer to, in response to the display parameters action directed to the call statement,
execute the executable program, and
halt the execution of the executable program after the temporary executable instructions and before the call executable instruction.

17. The method of claim 16, wherein the configuring the computer to halt the execution further comprises:
configuring the computer to execute the executable program until a boundary between the call statement and the parameter statement in the source program is reached.

18. The method of claim 15, wherein the display parameter action is directed to the call statement if the display parameter action is initiated while the executable program is halted at a statement boundary prior to the call statement.

19. The method of claim 15, further comprising:
configuring the computer to, in response to a step over action directed to the call statement,
execute the parameter executable instructions,
execute the temporary executable instructions, and
execute the call instruction.

20. The method of claim 15, wherein the parameter further comprises a parameter expression, and wherein the temporary executable instructions further calculate the parameter expression.
